(19) United States
(12) Patent Application Publication
(10) Pub. No.: US 2026/0030111 A1
(43) Pub. Date: Jan. 29, 2026

(54) REAL-TIME ASSISTANT FOR SOFTWARE INSTALLATION AND DEPLOYMENT

(71) Applicant: International Business Machines Corporation, Armonk, NY (US)

(72) Inventors: Cheng Fang Wang, Beijing (CN); Biao Cao, Beijing (CN); Jia Liu, Beijing (CN); Wen Hua Sun, Beijing (CN); Meng Chai, Shanghai (CN)

(21) Appl. No.: 18/788,026

(22) Filed: Jul. 29, 2024

(51) Int. Cl. G06F 11/14; G06F 8/61

(52) U.S. Cl. CPC G06F 11/1433; G06F 8/61

(57) ABSTRACT

An example operation may include one or more of receiving a report of an error from an installation process of a software program as the installation process is being performed by a computer, executing an artificial intelligence (AI) model to predict at least one instruction to fix the error based on the report of the error, and presenting the at least one instruction via a graphical user interface of the computer associated with the installation process.

### BACKGROUND

During a software installation process, various problems are often encountered which prevent the software from properly being installed. A person performing the installation may seek help by searching for solutions online in an effort to troubleshoot the problem. Also, the person may seek help from colleagues, friends, online forums, etc., which have experienced similar problems. However, these solutions are fragmented and delay the installation process.

### SUMMARY

One example embodiment provides a computer-implemented method that includes one or more of receiving a report of an error from an installation process of a software program as the installation process is being performed by a computer, executing an artificial intelligence (AI) model on the report of the error such that the AI model generates a prediction comprising at least one instruction to fix the error, and presenting the at least one instruction via a graphical user interface of the computer associated with the installation process.

Another example embodiment provides a computer system that may include a processor set, a set of one or more computer-readable storage media, and program instructions, collectively stored in the set of one or more storage media, that causes the processor set to perform computer operations to one or more of receive a report of an error from an installation process of a software program as the installation process is being performed by a computer, execute an artificial intelligence (AI) model on the report of the error such that the AI model generates a prediction comprising at least one instruction to fix the error, and present the at least one instruction via a graphical user interface of the computer associated with the installation process.

A further example embodiment provides a computer program product that may include a set of one or more computer-readable storage media, and program instructions, collectively stored in the set of one or more computer-readable storage media, for causing a processor set to perform computer operations including one or more of retrieving historical information about software installation from at least one source, extracting installation steps and associated errors from the retrieved historical information, the installation steps having been performed via previous successful installations, generating training data from the extracted installation steps and from the extracted associated errors, and using the training data to train an artificial intelligence model to predict an instruction to recommend for furthering a software installation that is stuck on an error.

### BRIEF DESCRIPTION OF THE DRAWINGS

FIG. 1 is a diagram illustrating a computing environment according to an embodiment of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3 is a system diagram illustrating an operating environment for an installation assistant service, according to examples and features of the instant solution.

FIG. 4 is a diagram illustrating a process of monitoring a software installation process according to example embodiments.

FIG. 5A is a diagram illustrating a system for providing real-time guidance in response to errors during a software installation process according to example embodiments.

FIG. 5B is another diagram illustrating a system for providing real-time guidance in response to errors during a software installation process according to example embodiments.

FIG. 5C is yet another diagram illustrating a system for providing real-time guidance in response to errors during a software installation process according to example embodiments.

FIG. 6 is a diagram illustrating a process of displaying real-time guidance during a software installation process according to example embodiments.

FIG. 7A illustrates a flow diagram, according to example embodiments.

FIG. 7B illustrates a flow diagram, according to additional example embodiments.

FIG. 7C illustrates a flow diagram, according to additional example embodiments.

FIG. 7D illustrates a flow diagram, according to additional example embodiments.

FIG. 8 is a diagram illustrating a process of training an AI model according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a computer system that includes a processor set, a set of one or more computer-readable storage media, and program instructions, collectively stored in the set of one or more storage media, for causing the processor set to perform operations to train an artificial intelligence (AI) model using a neural network training capability based on training data including at least one of workflows of successful software installations, workflows of unsuccessful software installations, and model feedback data, receive a report of an error from an installation process of a software program as the installation process is being performed by a computer, execute the trained AI model to predict at least one instruction to fix the error based on the report of the error, and present the at least one instruction via a graphical user interface of the computer associated with the installation process. The apparatus has the technical effect of facilitating the fixing of a software installation process that has errors thereby enabling the installation process to be performed even in situations where the user has not succeeded by themselves to properly install the software. A technical advantage of the apparatus is that the software installation can be fixed in real-time (or near real-time) without a need for accessing external resources such as a search engine, colleagues, etc.

In embodiments, the processor set is configured to receive at least one of an identifier of an error code, an error message associated with the error code, and an identifier of the software program, and execute the trained AI model on the at least one of the identifier of the error code, the error message, and the identifier of the software program to predict the at least one instruction. The technical advantage of this feature is that specific details of the problem with the installation process can be used to quickly identify a proper solution to the problem.

In some embodiments, the processor set is configured to retrieve log data from previous successful installations of the software program, extract steps performed during the previous installations, and generate the training data to include the steps performed during the previous installations. The technical advantage of this feature is that training data for the AI model can be generated from live runtime data of successful installations of the software.

In some embodiments, the processor set is further configured to retrieve knowledge base data of the software application from at least one data source, extract error types and workflow steps to perform during installation to address the error types from the knowledge base, and generate the training data to include the error types and the workflow steps to perform to address the error types. The technical advantage of this feature is that best practices for software installation may be added to the training data and used to train the AI model to learn the best practices for software installation.

In some embodiments, the processor set is configured to execute the trained AI model to predict a plurality of workflows to be performed to fix the error and a respective probability value for each workflow from among the plurality of workflows. The technical advantage of this feature is that multiple solutions for correcting the error of the software installation process can be generated and provided.

In some embodiments, the processor set is further configured to select a workflow from among the plurality of workflows based on a probability value assigned to the workflow, and present instructions for performing the workflow via the graphical user interface. The technical advantage of this feature is that the best solution or a subset of best solutions output by the AI model can be selected and presented to fix the error of the software installation.

In some embodiments, the processor set is further configured to receive feedback data indicating whether or not the at least one instruction fixed the error, generate a feedback record including the feedback data, add the feedback record to the model feedback data, and retrain the model based on the model feedback data including the added feedback record. The technical advantage of this feature is an improved AI model which is the result of learning from recent installation experience.

According to an aspect of the example embodiments, there is provided a method that includes training an artificial intelligence (AI) model using a neural network training capability based on training data including at least one of workflows of successful software installations, workflows of unsuccessful software installations, and model feedback data, receiving a report of an error from an installation process of a software program as the installation process is being performed by a computer, executing the trained AI model to predict at least one instruction to fix the error based on the report of the error, and presenting the at least one instruction via a graphical user interface of the computer associated with the installation process. The method has the technical effect of fixing a software installation process that has errors thereby enabling the installation process to be performed even in situations where the user is unable to properly install the software. A technical advantage of the method is that the installation can be fixed in real-time without a need for accessing external resources such as a search engine, colleagues, etc.

In some embodiments, the receiving includes receiving at least one of an identifier of an error code, an error message associated with the error code, and an identifier of the software program, and executing the trained AI model on the at least one of the identifier of the error code, the error message, and the identifier of the software program to predict the at least one instruction. The technical advantage of this feature is that specific details of the problem with the installation process can be used to quickly identify a proper solution to the problem.

In some embodiments, the method includes retrieving log data from previous successful installations of the software program, extracting steps performed during the previous installations, and generating the training data to include the steps performed during the previous installations. The technical advantage of this feature is that training data for the AI model can be generated from live runtime data of successful installations of the software.

In some embodiments, the method includes retrieving knowledge base data of the software application from at least one data source, extracting error types and workflow steps to perform during installation to address the error types from the knowledge base, and generating the training data to include the error types and the workflow steps to perform to address the error types. The technical advantage of this feature is that best practices for software installation may be added to the training data and used to train the AI model to learn the best practices for software installation.

In some embodiments, the method includes executing the trained AI model to predict a plurality of workflows to be performed to fix the error and a respective probability value for each workflow from among the plurality of workflows. The technical advantage of this feature is that multiple solutions for correcting the error of the software installation process can be generated and provided.

In some embodiments, the method includes selecting a workflow from among the plurality of workflows based on a probability value assigned to the workflow, and presenting instructions for performing the workflow via the graphical user interface. The technical advantage of this feature is that the best solution or a subset of best solutions output by the AI model can be selected and presented to fix the error of the software installation.

In some embodiments, the method includes receiving feedback data indicating whether or not the at least one instruction fixed the error, generating a feedback record including the feedback data, adding the feedback record to the model feedback data, and retraining the model based on the model feedback data including the added feedback record. The technical advantage of this feature is using outputs generated by the AI model to retrain the AI model thereby improving the AI model.

According to an aspect of the example embodiments, there is provided a computer program product that includes a set of one or more computer-readable storage media, and program instructions, collectively stored in the set of one or more computer-readable storage media, for causing a processor set to perform computer operations that includes training an artificial intelligence (AI) model using a neural network training capability based on training data including at least one of workflows of successful software installations, workflows of unsuccessful software installations, and model feedback data, receiving a report of an error from an installation process of a software program as the installation process is being performed by a computer, executing the trained AI model to predict at least one instruction to fix the error based on the report of the error, and presenting the at least one instruction via a graphical user interface of the computer associated with the installation process. The method has the technical effect of fixing a software installation process that has errors thereby enabling the installation process to be performed even in situations where the user is unable to properly install the software. A technical advantage of the method is that the installation can be fixed in real-time without a need for accessing external resources such as a search engine, colleagues, etc.

In some embodiments, the receiving includes receiving at least one of an identifier of an error code, an error message associated with the error code, and an identifier of the software program, and executing the trained AI model on the at least one of the identifier of the error code, the error message, and the identifier of the software program to predict the at least one instruction. The technical advantage of this feature is that specific details of the problem with the installation process can be used to quickly identify a proper solution to the problem.

In some embodiments, the processor set is further configured to perform retrieving log data from previous successful installations of the software program, extracting steps performed during the previous installations, and generating the training data to include the steps performed during the previous installations. The technical advantage of this feature is that training data for the AI model can be generated from live runtime data of successful installations of the software.

In some embodiments, the processor set is further configured to perform retrieving knowledge base data of the software application from at least one data source, extracting error types and workflow steps to perform during installation to address the error types from the knowledge base, and generating the training data to include the error types and the workflow steps to perform to address the error types. The technical advantage of this feature is that best practices for software installation may be added to the training data and used to train the AI model to learn the best practices for software installation.

In some embodiments, the executing includes executing the trained AI model to predict a plurality of workflows to be performed to fix the error and a respective probability value for each workflow from among the plurality of workflows. The technical advantage of this feature is that multiple solutions for correcting the error of the software installation process can be generated and provided.

In some embodiments, the processor set is further configured to perform selecting a workflow from among the plurality of workflows based on a probability value assigned to the workflow, and presenting instructions for performing the workflow via the graphical user interface. The technical advantage of this feature is that the best solution or a subset of best solutions output by the AI model can be selected and presented to fix the error of the software installation.

In some embodiments, the processor set is further configured to perform receiving feedback data indicating whether or not the at least one instruction fixed the error, generating a feedback record including the feedback data, adding the feedback record to the model feedback data, and retraining the model based on the model feedback data including the added feedback record. The technical advantage of this feature is using outputs generated by the AI model to retrain the AI model thereby improving the AI model.

The example embodiments are directed to an artificial-intelligence (AI) assistant that can monitor a software installation process that occurs on a computer. When an error occurs during the installation process, the AI assistant can detect the error, and also identify a possible solution to fix the error in real-time. The solution may be presented on a graphical user interface of the computing system where the software installation is being performed. The AI assistant includes at least one AI model that is trained to recommend solutions based on error data from an installation process. The AI model may be trained based on workflows of successful software installation processes, best practices, feedback data, and the like. In some embodiments, the AI assistant may be hosted by a cloud platform and may monitor the installation from a system level of the cloud platform. As another example, the AI assistant may be embedded within the software application being installed, for example, as a plug-in.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

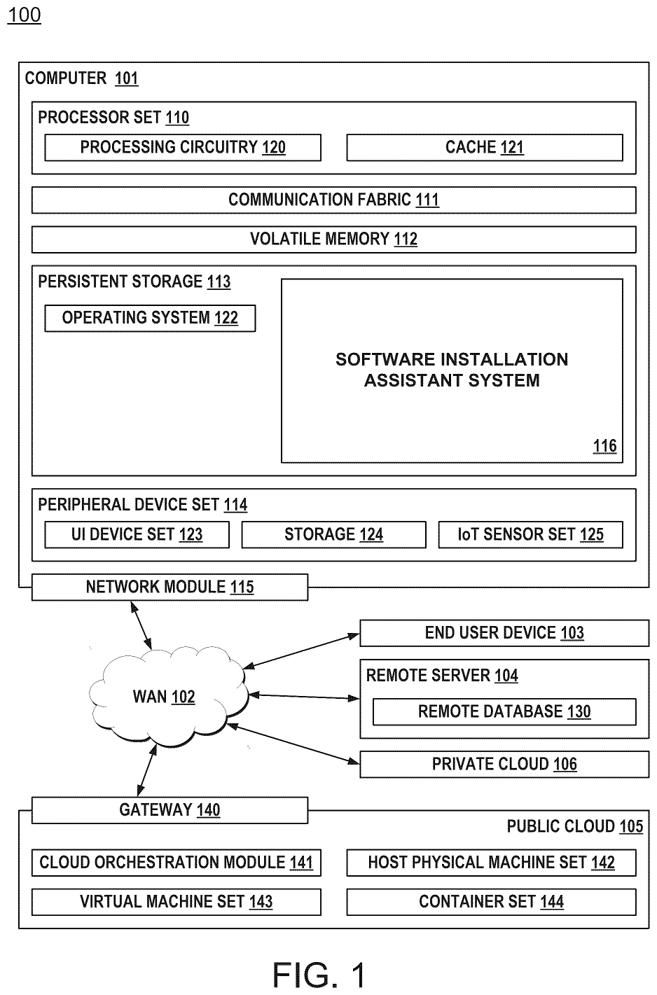

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a software installation assistant system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

Detailed descriptions of the real-time assistant for software installation in the instant solution are further described and depicted herein.

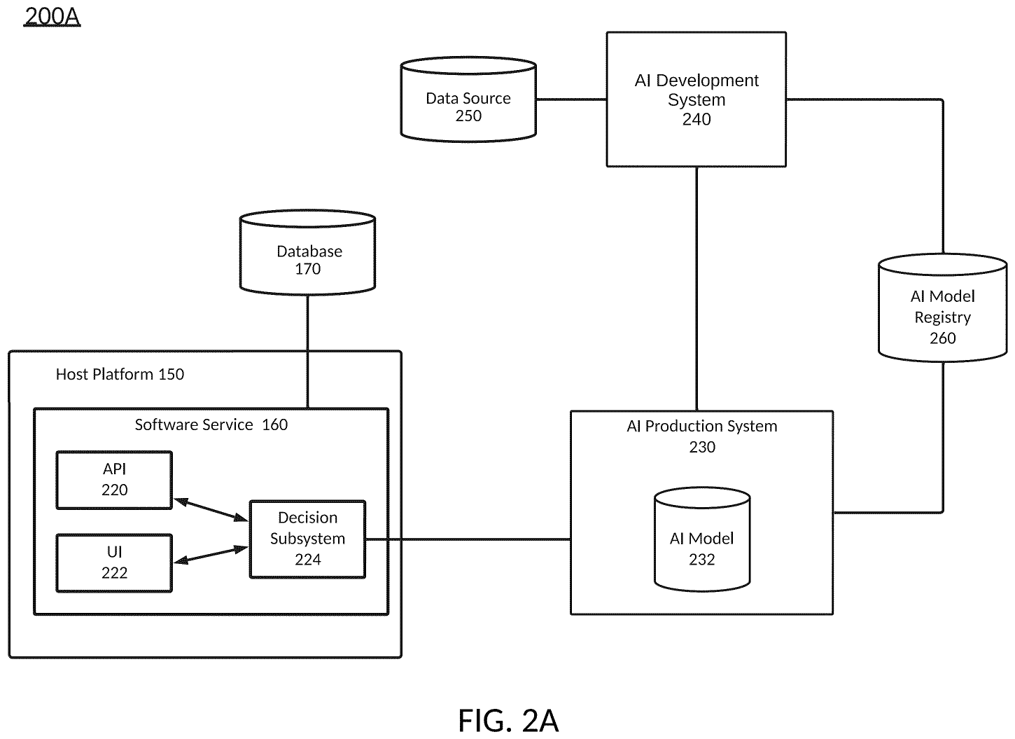

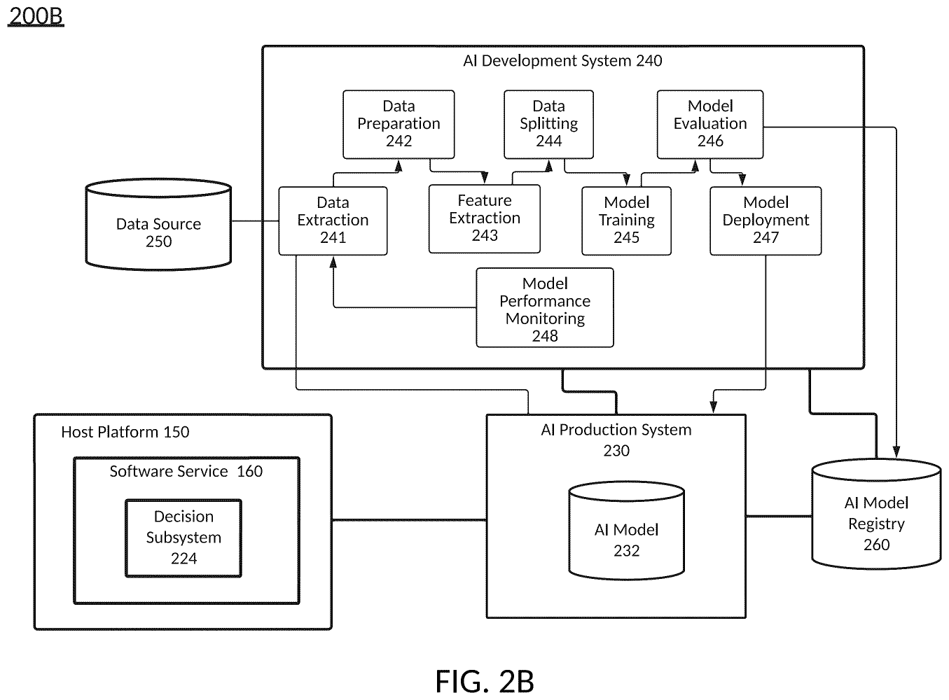

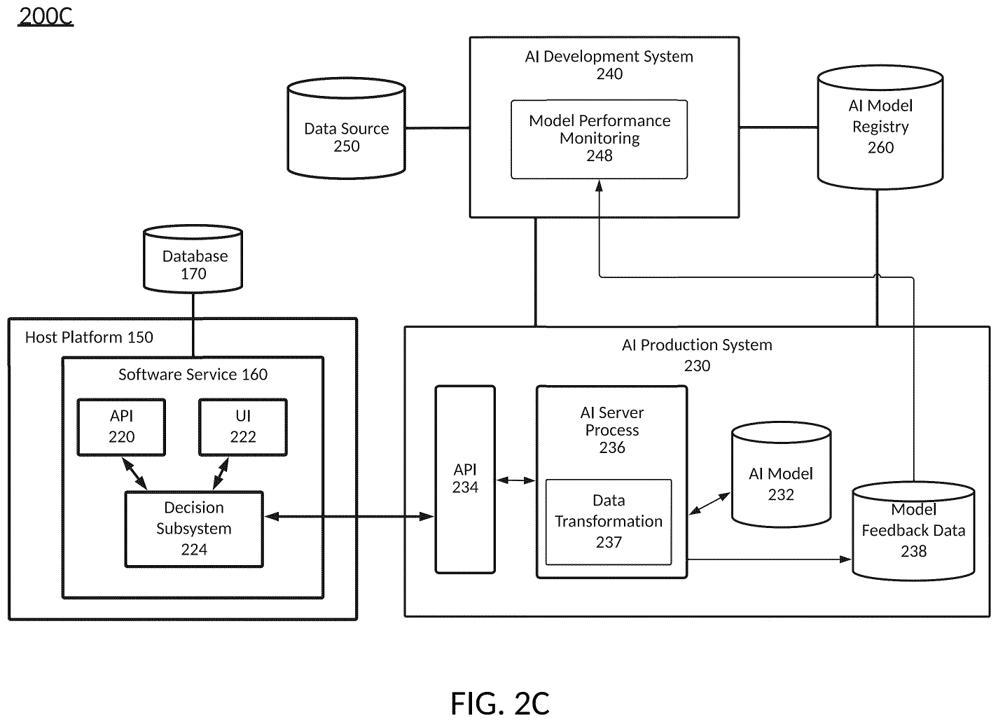

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 160 (see FIG. 2A), executing on host platform 150 (see FIG. 2A) may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 160 to assist in decision-making. In some examples and features of the instant solution, the software service 160 stores data included in API requests or data generated during processing the API requests into one or more databases 170 (see FIGS. 1, 2A).

Software service 160 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 160 to assist with decision-making. In some examples and features of the instant solution, the software service 160 stores data included in UI requests or data generated during processing the UI requests into one or more databases 170.

Software service 160 may include one or more decision subsystems 224 that drive a decision-making process of the software service 160. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 170 to aid in the decision-making process. A decision subsystem 224 may provide feedback to an API 220 or a UI 222.

An AI production system 230 may be used by a decision subsystem 224 in a software service 160 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 160 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 160, UI 222 data from software service 160 or data from other software service 160 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 160. In some examples and features of the instant solution, the response may result in an update to a UI 222 in software service 160. In some examples and features of the instant solution, the response includes a request identifier that can be used later by the software service 160 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

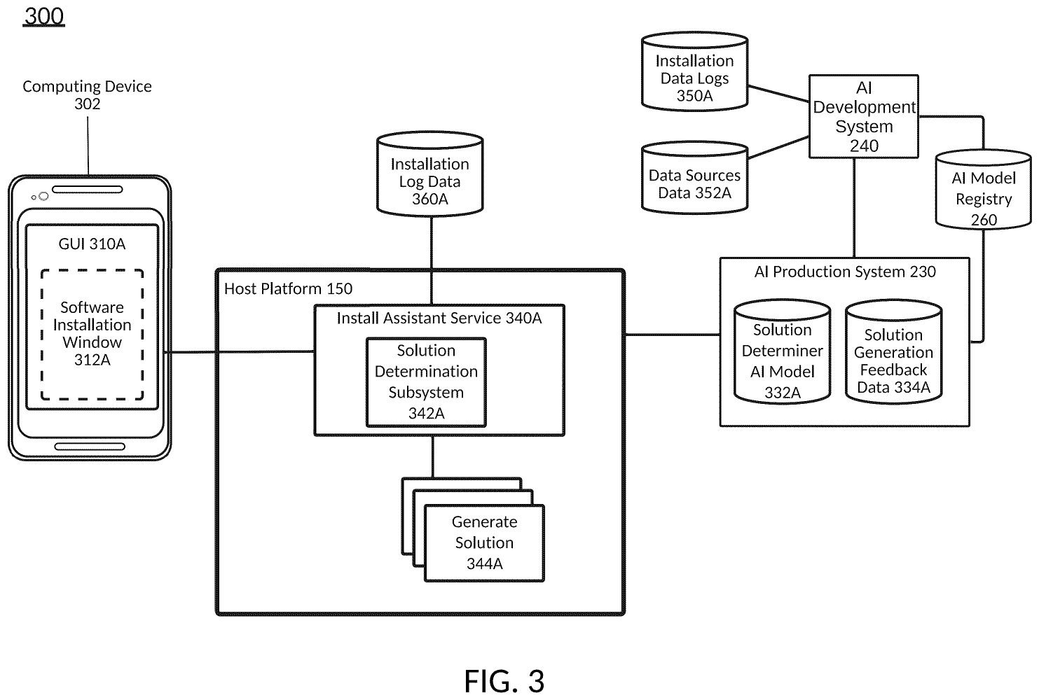

FIG. 3 is a system diagram illustrating an operating environment 300 for an installation assistant service that provides real-time solutions to issues encountered during a software installation process according to examples and features of the instant solution. In operating environment 300, an AI model is trained to determine solutions to errors that occur during a software installation process using logs of previous successful installation processes, previous unsuccessful installation processes, fixes used to address previous unsuccessful installation processes, feedback data, and the like. For example, the AI model may be trained based on the examples described with respect to FIGS. 2A-2C; however, embodiments are not limited thereto.

In some examples and features of the instant solution, a solution determination AI model 332A is trained using historical logs of previous software installations 350A, best practices and other guidance from one or more external data sources 352A, and solution generation feedback data 334A to generate a solution to an error during a software installation process given a set of feature data transformed from a workflow of the software installation process. The solution determination AI model 332A is an example of AI Model 232 (see, for example, FIGS. 2A-2C). The historical logs of previous software installations 350A and the best practices and other guidance from one or more external data sources 352A are examples of data source 250 (see, for example, FIGS. 2A-2C).

In some examples and features of the instant solution, the solution determination AI model 332A is trained using one or more neural network training methods such as, but not limited to, gradient descent, stochastic gradient descent, random search, uniform search, basin hopping, and Krylov. In some examples and features of the instant solution, the solution determination AI model 332A is a single or multi-layer perceptron neural network, a feed-forward neural network, a radial basis functional neural network, a recurrent neural network, or a modular neural network.

In some examples and features of the instant solution, the solution determination AI model 332A may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data may include, but is not limited to, logs of previous software installations, documents and other data representing best practices for software installation, and the like. In some examples and features of the instant solution, the training data for the solution determination AI model 332A may include, but is not limited to, internal data sources, external data sources, private data sources, public data sources, account data, third party data, configuration data, range data, or the like.

In some examples and features of the instant solution, the installation log data may include but is not limited to workflows that are performed during a software installation process. The workflows may include the steps that are performed, or otherwise recommended to be performed, during an installation of a software program such as a software application, software service, driver, or the like. The model feedback records in the model feedback data 334A may include, but are not limited to, indicators of whether a respective suggested solution output by the solution determination AI model 332A is correct (e.g., whether it fixed the error, etc.). In some examples and features of the instant solution, many solutions may be generated by the solution determination AI model 332A with each solution being assigned a numerical value that identifies a confidence, a probability, etc. of the solution being successful. Once the solution determination AI model 332A is trained and validated, it is deployed to an AI production system 230 (see, for example, FIGS. 2A-2C, 3) for use by an installation assistant service 340A. The installation assistant service 340A is an example of software service 160 (see, for example, FIGS. 2A-2C).

The installation assistant service 340A may monitor a software installation process that is being performed on a computer 302 and capture log data of the software installation process. Here, the installation assistant service 340A may detect an error that occurs during the installation of the software on the computer 302. For example, the installation assistant service 340A may detect that the installation process is stuck based on values displayed on a display device 310A of the computer 302, instructions output by the software, and the like. In response, the installation assistant service 340A may transfer the log data of the software installation process to the solution determination AI model 332. In this example, the solution determination AI model 332 may predict a solution to fix or otherwise address the error and enable the software installation process to resume on the computer 302.

A user performing the software installation process on the computer 302 may be presented with instructions on how to address the error that occurs during the software installation process. For example, the instructions may be generated by the solution determination AI model 332 based on the log data provided by the installation assistant service 340A. Here, the instructions may be presented with options on a display device (GUI) 310A of the computer 302. The instructions may include one or more steps to be taken, actions to be performed, etc., by the user to fix the error with the installation process, and resume the installation process in case it is stuck. The GUI 310A may be displayed next to or within a software installation window 312A which shows the status of the installation process of the software being installed. The GUI 310A may also provide input mechanisms that enable the user to provide feedback about the suggested instructions to fix the error. Here, the data is collected and may be sent to the installation assistant service 340A.

In some examples and features of the instant solution, the installation assistant service 340A receives error data, steps performed, etc. of the installation process from the computer 302. The error data may include an identifier of the software being installed such as an application identifier, an error message, an error code, a version of the software, and the like. Once a set of required data for solution prediction is received, a solution determination subsystem 342A of the installation assistant service 340A initiates a request for a solution from the solution determination AI model 332A resident on the AI production system 230 (see, for example, FIGS. 2A-2C, 3), by supplying the set of required data. In some examples and features of the instant solution, the installation assistant service 340A may continue to receive and process data from the software installation window 312A of the computer 302 in parallel to the solution being generated by the solution determination AI model 332A.

In some examples and features of the instant solution, upon receiving the request, the AI production system 230 (see FIGS. 2A-2C, 3), transforms 237 (see FIG. 2C) the set of required data into a set of valid feature values in the solution determination AI model 332A. The solution determination AI model 332A is then executed with the transformed data. The result of the execution is the generation of a plurality of predicted solutions (e.g., workflows, sequence of steps, etc.) to be performed to solve the problem, a confidence value or probability value of each of the predicted solutions, and the like. In some examples and features of the instant solution, one or more of the predicted solutions (e.g., a top 3, etc.) are returned in a response to the solution determination subsystem 342A of the installation assistant service 340A. In some examples and features of the instant solution, the response includes a request identifier that can be used by the installation assistant service 340A to provide feedback on the performance of the solution determination AI model 332A.

In some examples and features of the instant solution, upon receiving the response, the solution determination subsystem 342A determines at least one solution generation process 344A to be performed and in parallel the installation assistant service 340A may continue to receive and process data from the software installation window 312A. In some examples and features of the instant solution, the solution determination subsystem 342A utilizes workflows included in the installation log data 360A to generate the solution to be performed. The installation log data 360A may be stored in a data store such as database 170.

In some examples and features of the instant solution, after all of the at least one solution generation processes 344A are completed, a GUI 310A of the computer 302 being used to perform the software installation process and which includes the software installation window 312A may be updated with a solution to reflect a final result of the at least one solution generation process 344A. In some examples and features of the instant solution, the GUI 310A is updated in real-time. In some examples and features of the instant solution, the GUI is updated when the final result of the at least one solution generation process 344A is determined.

In some examples and features of the instant solution, all of the at least one solution generation process 344A must be successful in order for the final result to be considered successful. In some examples and features of the instant solution, a solution generation process 344A is considered incomplete when a technical issue prevents its timely completion and an incomplete fraud profile/fraud indicator results in a failed final result. In some examples and features of the instant solution, an incomplete solution generation process 344A does not impact the final result when a minimum number of the at least one solution generation process 344A completes successfully.

According to various embodiments, an AI assistant can monitor a live installation of a software program on a computer. The software program may include a software application, a software update, a plug-in, a driver, an operating system, and the like. The AI assistant may detect when an error has occurred during the installation process. In response, the AI assistant can determine a possible solution to the error and display the solution within a window on the computer where the software is being installed.

In some embodiments, the software to be installed may be downloaded from a host platform, such as a cloud platform, web server, or the like, and may be installed on a remote device that is connected to the host platform over a computer network. Here, the AI assistant may be running on the host platform and may monitor the installation process through a back-end of the software being installed. As another example, the AI assistant may be integrated into the software program being installed as a plugin. In either scenario, the AI assistant may monitor the installation process as it is occurring (in real-time) and detect an error when it occurs. In this case, the AI assistant may receive error data such as an error report, message, code, etc. and predict a solution for the error based on execution of an AI model on the error data. The solution may be presented to a GUI on the computer where the software is being installed thereby enabling a user to understand what to do to fix the error.

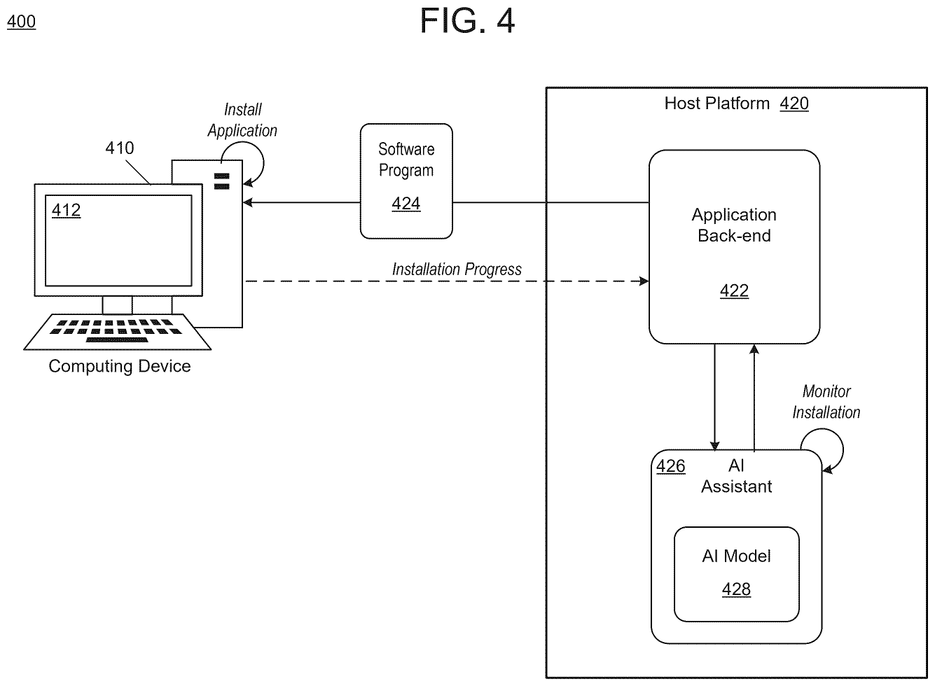

FIG. 4 illustrates a process 400 of monitoring a software installation process according to example embodiments. Referring to FIG. 4, a host platform 420 may host a software application back-end 422. In this example, the host platform 420 may be a cloud platform, a web server, or the like. A computer 410 may connect to the host platform 420 over a computer network such as the Internet. Here, the computer 410 may include a web browser, software application, or the like, which can access the software application back-end 422 hosted on the host platform 420. The computer 410 may download a software program 424, such as a software update, a front-end of a software application, a driver, or the like, and may install the software program 424 on the computer 410.

To install the software program 424, a user may locate and download an executable file from the host platform 420 (e.g., the software program 424). In addition, the user may click, double-click, touch, or otherwise select the executable file through a command on a display screen 412 of the computer 410. Here, the display screen 412 may be a display device capable of displaying a graphical user interface (GUI) or the like with content associated with the installation process. While the software is being installed on the computer 410, status information, progress information, and the like, about the installation process may be transmitted back to the software application back-end 422.

According to various embodiments, an AI assistant 426 (e.g., a software program, service, application, plug-in, etc.) running on the host platform 420 may monitor the progress/status data of the software installation process from the computer 410. When an error is detected, the AI assistant 426 may extract error data from the progress/status data provided from the computer 410, and execute an AI model 428 on the error data to generate a possible solution to the error. The AI assistant 426 may provide the solution to the software application back-end 422, which then presents the solution on the display screen 412 of the computer 410 thereby enabling a user to view the steps to take. In some cases, the solution may include one or more steps to be performed by the user to fix or otherwise correct the error and successfully perform the installation process.

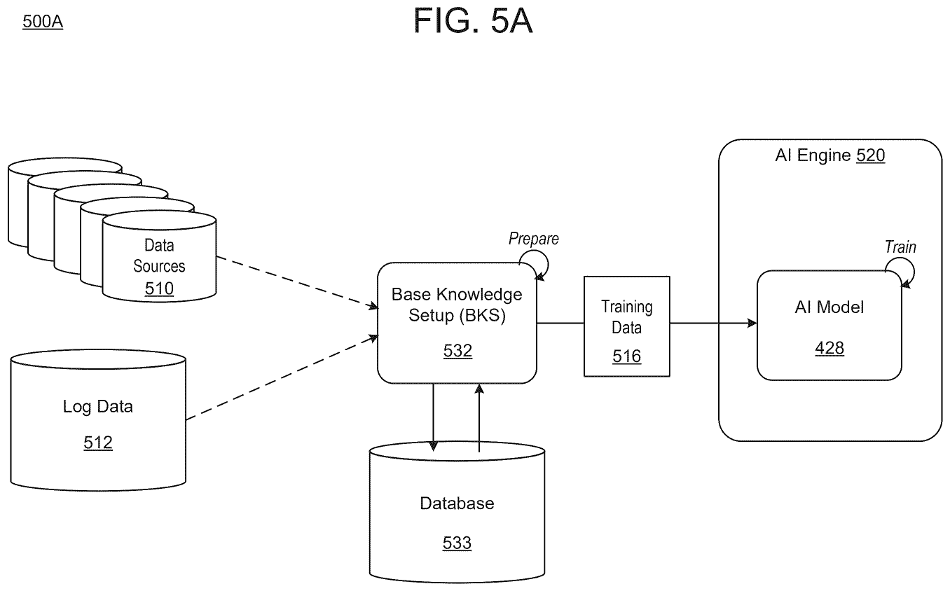

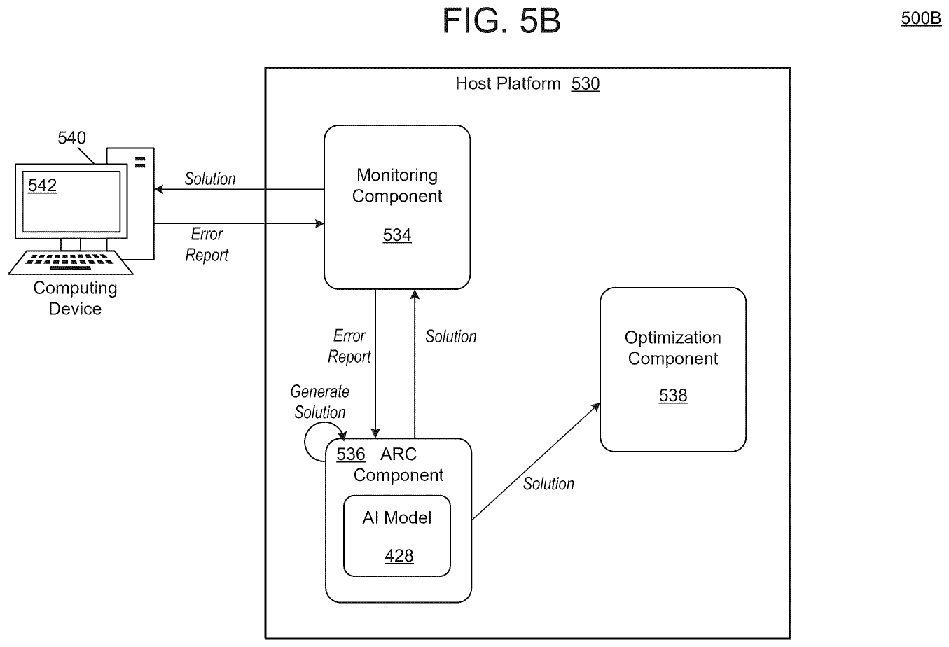

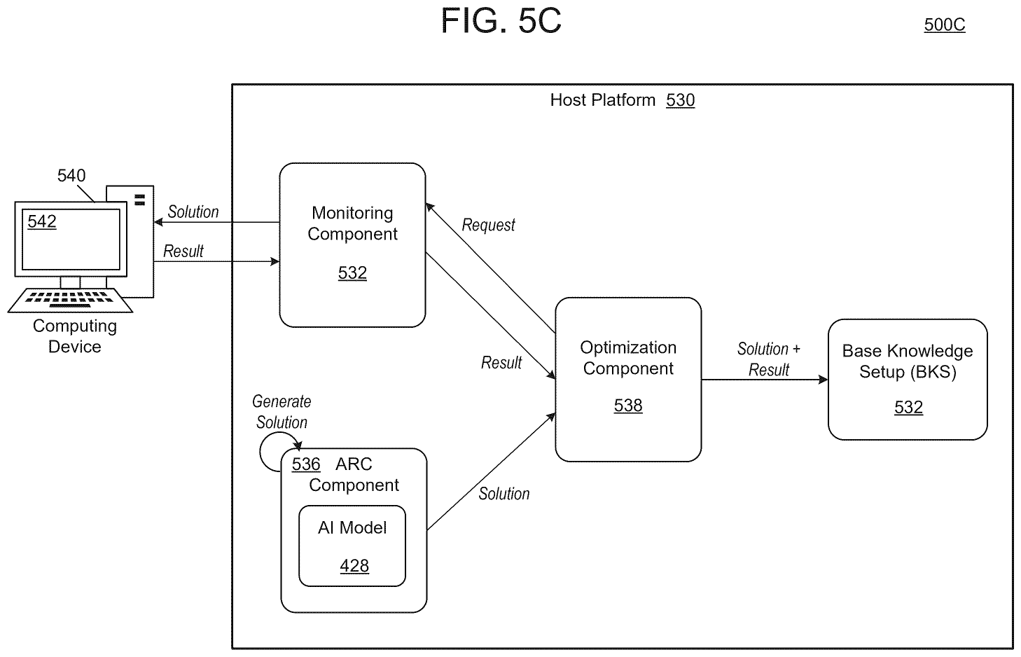

FIGS. 5A-5C illustrate a system for providing real-time guidance in response to errors during a software installation process according to example embodiments. In these examples, the system includes a base knowledge setup (BKS) component 532, a monitoring component 534, an analysis and recommendation (ARC) component 536, and an optimization component 538. In these examples, the BKS component 532 may generate training data for training an artificial intelligence (AI) model 428 included within the ARC component 536. The training process may be performed via a host platform 530, shown in the examples of FIG. 5B.

During the training process, the AI model 428 may iteratively execute on input data that includes at least one of log data of previous successful installations of a software program, log data of previous unsuccessful installations of the software program, documents, manuals, and the like, with best practices for the software installation of the software program, and the like. The data may be formatted and stored within a database 533 where it can be accessed during model training. An example of the model training process is shown and described with respect to FIGS. 2A-2C. In addition, the training data may be formatted as shown in the example below:
standard workflow A:

```
{
  ● “steps”:
  ● [
    ∘ {
      ▪ “id”: 1,
      ▪ “action”: download the software
      ▪ “condition“:
      ▪ {
        ▪ “website“: official link,
        ▪ “version“: latest version,
        ▪ ...
      ▪ }
    ∘ }.
    ∘ {
      ▪ “id”: 2,
      ▪ “action”:”Check system requirements”
      ▪ “condition“:
      ▪ {
        ▪ “Storage space”: 500M,
        ▪ “Memory“: 8G,
        ▪ “Chip“: Apple M1 Max,
        ▪ “OS“: Sonoma 14.1.1,
        ▪ ...
    ∘ },
    ∘ {
      ▪ “id”: 3,
      ▪ “action”:”Close Other programs”
      ▪ “condition“:..
    ∘ },
    ∘ {
      ▪ “id”: 4
      ▪ “action”:“Run the installer”
      ▪ “condition“:...
    ∘ },
    ∘ {
      ▪ “id”: 5
      ▪ “action”:“Read the license agreement”
      ▪ “condition“:...
    ∘ },
    ∘ {
      ▪ “id”: 6,
      ▪ “action”:”Select an installation location”
      ▪ “condition“:...
    ∘ },
    ∘ {
      ▪ “id”: 7,
      ▪ “action”:“Installation options”
      ▪ “condition“:...
    ∘ },
    ∘ ...
  ● ]
}
```

FIG. 5A illustrates a process 500A of generating training data for the AI model 428 according to example embodiments. Referring to FIG. 5A, the BKS component 532 may ingest content such as document data, guidelines, manuals, and the like, from one or more data sources 510. As an example, the content may include best practices and other guidelines for installing various software programs.

Here, the one or more data sources 510 may include one or more of official documents such as user guides, manuals, specifications, etc., which can be word, pdf, txt and other formats. Here, the BKS component 532 may scan and read the contents of these files, and scan the contents of images and extract useful text information. Furthermore, word segmentation may be carried out by a text splitter. The data may be further segmented and merged by a large language model (LLM) or the like. Furthermore, error information may be used as the keyword to retrieve the data, and the error information and its corresponding solution may be sorted into structured data and stored in the database.

As another example, the one or more data sources 510 may include accumulated technical support data that includes notes on a particular solution to a particular problem which can be classified and error information can be extracted. In some cases, the technical support data may include audio and video data that can be converted to text data, and useless information can be filtered out. Because this part of data comes from real cases, it is also highly reliable. As another example, the one or more data sources 510 may include forums, message boards, and the like, from Internet/social platforms. Here, the data may be crawled from social media through crawler technology, and desensitized, and then gradually filtered, analyzed, extracted into formatted data and stored in the database 533. As another example, the one or more data sources 510 may include self-optimized solutions that are provided from the optimization component 538, and which are based on previously generated solutions and feedback from the previously generated solutions.

According to various embodiments, the AI model 428 may be iteratively executed by an AI engine 520 on training data 516 that is provided by the BKS component 532 from the one or more data sources 510, the log data 512, the database 533, and the like. When the AI model 428 is trained, the AI model 428 may be stored in a repository where it can be accessed during live runtime by the ARC component 536.

FIG. 5B illustrates a process 500B of detecting an error during a software installation process on a computer 540 via the system described herein, and outputting a solution to a display device 542 of the computer 540. Referring to FIG. 5B, the AI model 428 that is trained in the process shown in FIG. 5A, may be integrated into the ARC component 536. As another example, the AI model 428 may be a stand alone service that can be called/queried by the ARC component 536 for real-time execution. In this example, the computer 540 is attempting to install a software program (not shown). Here, the installation process results in an error being generated by the computer 540, and error data of the error being provided to the monitoring component 534. In this example, the monitoring component 534 may monitor the installation process, for example, by intercepting messages that are sent back and forth between the computer 540 and a back-end (such as the software application back-end 422 shown in FIG. 4), and detect the error data. As another example, the monitoring component 534 may monitor the error data directly from the software program being installed, for example, as a plugin of the software program.

In response to receiving the error data from the computer 540, the monitoring component 534 may request a solution from the ARC component 536. Here, the monitoring component 534 may transmit the error data to the ARC component 536. The error data may include one or more of an error code, an error message, a software identifier, a version identifier, and the like. Examples of error reports are shown below in Table 1.

TABLE 1

| Software | Error | | | |
|---|---|---|---|---|
| Name | Code | Error Message | OS | Workflow |
| Software X | 01 | A xx class | OS A | Step 1→ |
| | | cannot be found | | Step 2 → . . . |
| Software Z | 09 | YY installed | OS B | Step 1→ |
| | | bad permissions | | Step 2 → . . . |

In this example, the AI model 428 may receive the error data as input, and generate a solution to the error. The solution may include one or more steps from an installation workflow. Steps may include, but are not limited to, checking system requirements, checking existing software versions, creating or updating program files and folders, adding configuration data, making software accessible to a user, configuring components to run automatically, performing product activation, updating software versions, and the like. Any steps may be provided as a possible solution. In some cases, a subset of steps may be identified as a partial solution, beginning with the step where the problem occurred, or the like.

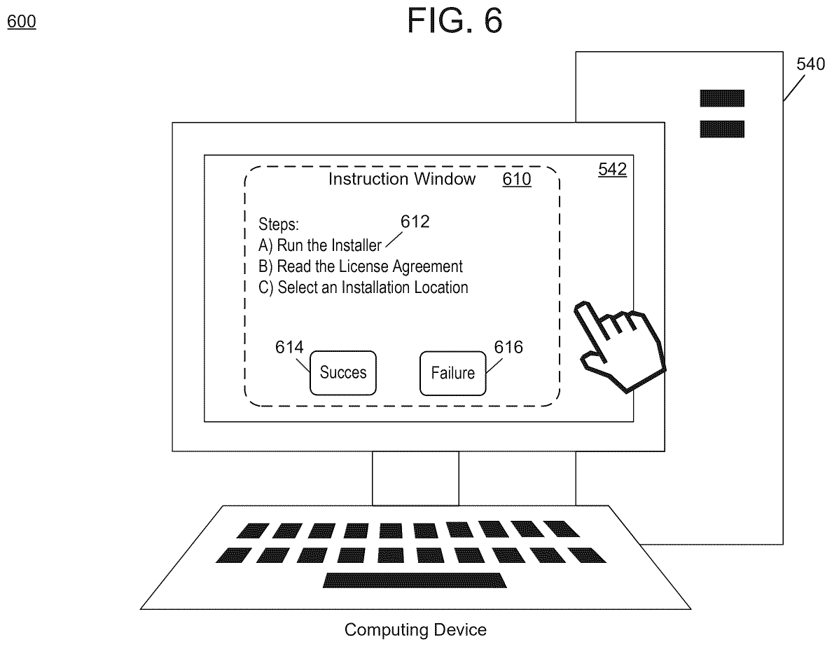

The solution generated by the AI model 428 may be provided to the monitoring component 534, which in turn, presents the solution on a graphical user interface, display window, or the like, on the display device 542 of the computer 540. Here, the solution may be displayed inside the display window with the details of the software installation process. As another example, the solution may be displayed in a separate window that is also on the screen with the display window, or the like. An example of a solution being displayed is shown in the example of FIG. 6.

For example, FIG. 6 illustrates a view 600 of real-time guidance during a software installation process according to example embodiments. Referring to FIG. 6, the computer 540 is shown with an instruction window 610 output on the display device 542. Here, the instruction window 610 may be part of the software installation window which includes the status/progress of the software installation process. As another example, the instruction window 610 may be a separate window such as an overlay that is laid over the software installation window on the display device 542, and the like.

In the example of FIG. 6, the instruction window 610 includes a list of steps from a workflow 612 which embody the recommended solution output by the AI model 428. In addition, the instruction window 610 includes feedback mechanisms including a feedback button 614 which enables a user to inform the monitoring component 534 of a successful solution and an additional feedback button 616 which enables the user to inform the monitoring component 534 of an unsuccessful solution. For example, by pressing on the feedback button 614 (or on the additional feedback button 616) on the instruction window 610, a notification may be sent to the monitoring component 534 that indicates the solution was successful (or for button 616 unsuccessful). The feedback may be used to further train the AI model 428.

Referring again to FIG. 5B, in addition to providing the solution to the monitoring component 534, the ARC component 536 may also provide the solution to the optimization component 538. The solution can be used for further training as is described in the example of FIG. 5C. For example, FIG. 5C illustrates a process 500C of generating training data for retraining the AI model 428 based on results that are output by the AI model 428 according to example embodiments.

Referring to FIG. 5C, the ARC component 536 may provide the solution to the optimization component 538. In addition, the optimization component 538 can query the monitoring component 534 for feedback on the solution received from the computer 540, such as feedback provided via the instruction window 610. Here, the monitoring component 534 may provide the feedback to the optimization component 538. The feedback may indicate whether the proposed solution output by the AI model 428 was able to fix the error or whether it did not fix the error. Both the solution and the feedback may be provided from the optimization component 538 to the BKS component 532 for further training of the AI model.

In some embodiments, the AI model 428 may be trained and retrained in a development environment and subsequently exported back to the live runtime environment of the host platform 530.

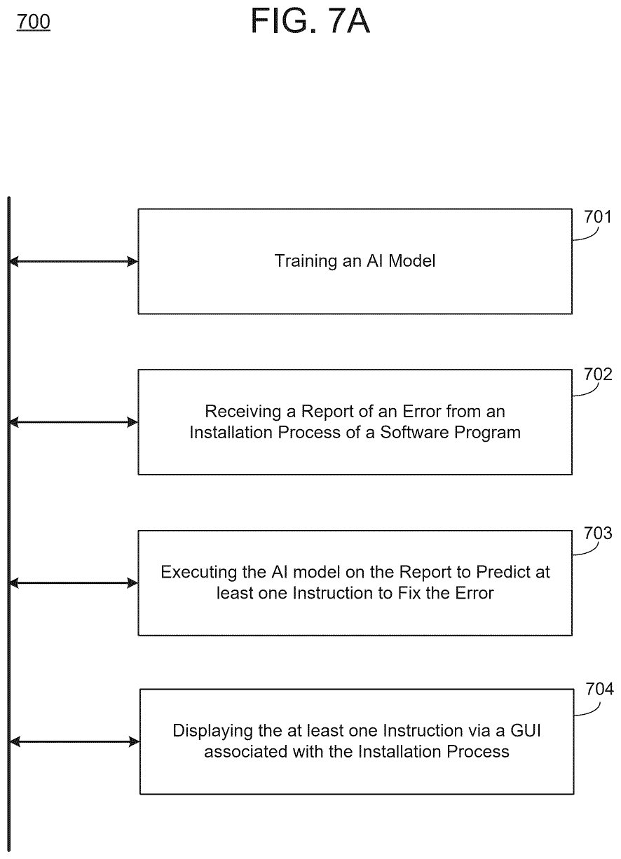

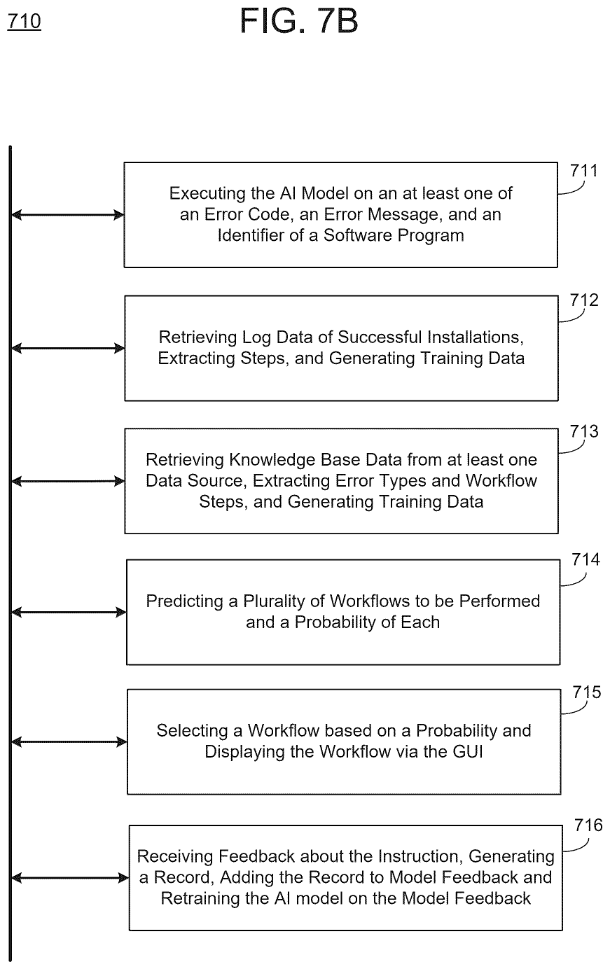

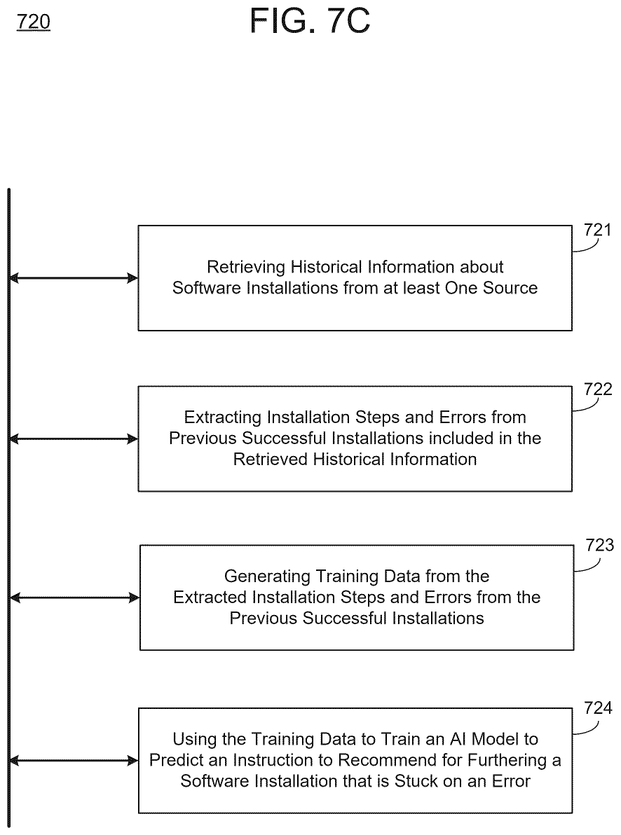

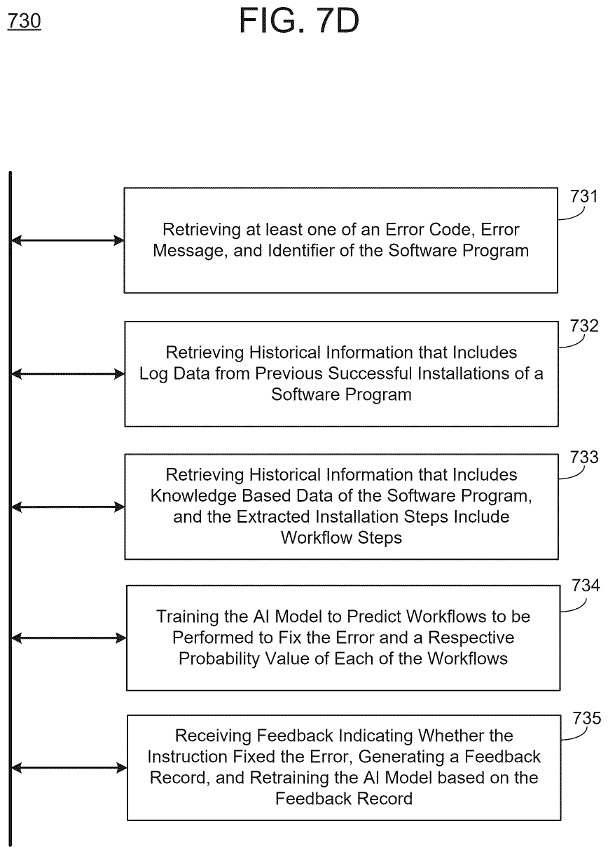

FIG. 7A illustrates a flow diagram of a method 700, according to example embodiments. Referring to FIG. 7A, the method 700 may include receiving a report of an error from an installation process of a software program as the installation process is being performed by a computer in 701. In 702, the method may include executing an artificial intelligence (AI) model on the report of the error such that the AI model generates a prediction comprising at least one instruction to fix the error. In 703, the method may include presenting the at least one instruction via a graphical user interface of the computer associated with the installation process.

FIG. 7B illustrates a flow diagram of a method 710, according to example embodiments. Referring to FIG. 7B, the method 710 may include receiving at least one of an identifier of an error code, an error message associated with the error code, and an identifier of the software program, and executing the AI model on the at least one of the identifier of the error code, the error message, and the identifier of the software program to predict the at least one instruction in 711. In 712, the method may further include retrieving log data from previous successful installations of the software program, extracting, from the log data, steps performed during the previous successful installations, generating training data from the extracted steps performed during the previous successful installations, and training the AI model using the training data, wherein the executing the AI model is performed via the trained AI model.

In 713, the method may further include retrieving knowledge base data of the software program from at least one data source, extracting error types and workflow steps to perform during installation to address the error types from the knowledge base data, generating training data to include the error types and the workflow steps to perform to address the error types, and training the AI model using the training data, wherein the executing the AI model is performed via the trained AI model. In 714, the method may further include executing the AI model to predict workflows to be performed to fix the error and a respective probability value for each of the workflows. In 715, the method may further include selecting a workflow from among the workflows based on a probability value assigned to the workflow, and presenting instructions for performing the workflow via the graphical user interface. In 716, the method may further include receiving feedback data indicating whether or not attempted implementation of the at least one instruction fixed the error, generating a feedback record including the feedback data, and retraining the AI model based on the feedback record.

FIG. 7C illustrates a flow diagram of a method 720, according to example embodiments.

Referring to FIG. 7C, the method 720 may include retrieving historical information about software installation from at least one source in 721. In 722, the method may further include extracting installation steps and associated errors from the retrieved historical information, the installation steps having been performed via previous successful installations. In 723, the method may further include generating training data from the extracted installation steps and from the extracted associated errors. In 724, the method may further include using the training data to train an artificial intelligence model to predict an instruction to recommend for furthering a software installation that is stuck on an error.

FIG. 7D illustrates a flow diagram of a method 730, according to example embodiments. Referring to FIG. 7D, the method 730 may include retrieving historical information that includes at least one of an identifier of an error code, an error message associated with the error code, and an identifier of the software program in 731. In 732, the method may include retrieving historical information that includes log data from previous successful installations of a software program. In 733, the method may include retrieving historical information that includes knowledge base data of the software program from at least one data source and the extracted installation steps comprise workflow steps. In 734, the method may include training the AI model to predict workflows to be performed to fix the error and a respective probability value for each of the workflows. In 735, the method may include receiving feedback data indicating whether or not the at least one instruction fixed the error, generating a feedback record including the feedback data, and retraining the AI model based on the feedback record.

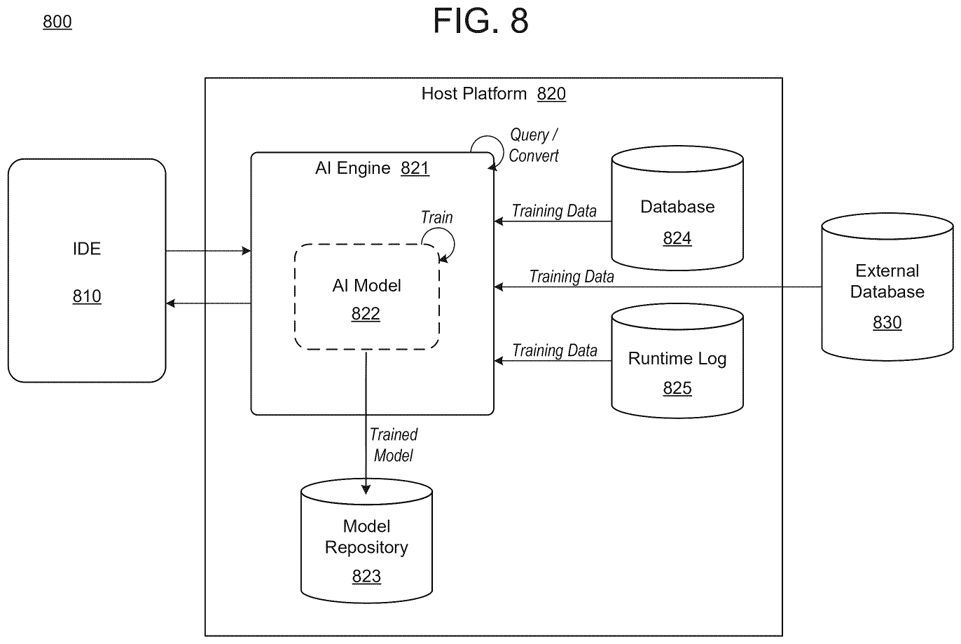

FIG. 8 illustrates a process 800 of training an AI model 822 according to example embodiments. However, it should be appreciated that the process 800 shown in FIG. 8 is also applicable to other types of models such as machine learning models, statistical models, and the like. Referring to FIG. 8, a host platform 820 may host an IDE 810 (integrated development environment) where models may be developed, trained, retrained, and the like. In this example, the IDE 810 may include a software application with a user interface accessible by a user device (not shown) over a network or through a local connection. For example, the IDE 810 may be embodied as a web application that can be accessed at a network address, URL, etc. by a device. As another example, the IDE 810 may be locally or remotely installed on a computing device where it is accessed and used locally.

The IDE 810 may be used to design an AI model 822 (via a user interface of the IDE 810) that can predict an instruction to recommend for furthering a software installation that is stuck on an error. The model can be executed/trained based on historical information about software installations from at least one source. The historical information may include installation steps and associated errors that are encountered during the software installations which can be extracted from the historical information. Here, the installation steps may include installation steps performed during previous successful installations of the software. The historical information for training such a new model may be provided from a training data store such as a database 824 which includes training samples (e.g., log data of historical software installations, etc.) from the web, from users of one or more software applications, and the like. As another example, the training data may be pulled from one or more external data stores 830 such as publicly available sites, etc.

During training, the AI model 822 may be executed on training data via an AI engine 821 of the host platform 820. The training data may include historical software installation data. The AI model 822 may learn how to recommend instructions to fix problems that occur during the installation process. For example, the AI model 822 may predict workflows to be performed to fix an error and a respective probability value for each of the workflows. One or more of these workflows may be output by the AI model as a possible solution. When the AI model 822 is fully trained, it may be stored within the model repository 823 via the IDE 810, or the like.

As another example, the IDE 810 may be used to retrain the AI model 822 after the model has already been deployed. The retraining process may use executional results that have already been generated/output by the AI model 822 in a live environment (including any user feedback, etc.) to retrain the AI model 822. For example, feedback data indicating whether or not the at least one instruction output by the AI model 822 fixed the error may be provided during runtime of the AI model 822. Here, a feedback record including the feedback data may be generated and stored within a data store such as a runtime log 825. The feedback data stored within the runtime log 825 may be used for retraining the AI model 822 based on the feedback record.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
receiving a report of an error from an installation process of a software program as the installation process is being performed by a computer;
executing an artificial intelligence (AI) model on the report of the error such that the AI model generates a prediction comprising at least one instruction to fix the error; and
presenting the at least one instruction via a graphical user interface of the computer associated with the installation process.

2. The computer-implemented method of claim 1, wherein the report of the error comprises at least one of an identifier of an error code, an error message associated with the error code, and an identifier of the software program, and the executing the AI model comprises executing the AI model on the at least one of the identifier of the error code, the error message, and the identifier of the software program to predict the at least one instruction.

3. The computer-implemented method of claim 1, further comprising retrieving log data from previous successful installations of the software program, extracting, from the log data, steps performed during the previous successful installations, generating training data from the extracted steps performed during the previous successful installations, and training the AI model using the training data, wherein the executing the AI model is performed via the trained AI model.

4. The computer-implemented method of claim 1, further comprising retrieving knowledge base data of the software program from at least one data source, extracting error types and workflow steps to perform during installation to address the error types from the knowledge base data, generating training data to include the error types and the workflow steps to perform to address the error types, and training the AI model using the training data, wherein the executing the AI model is performed via the trained AI model.

5. The computer-implemented method of claim 1, wherein the executing the AI model comprises executing the AI model to predict workflows to be performed to fix the error and a respective probability value for each of the workflows.

6. The computer-implemented method of claim 5, wherein the presenting comprises selecting a workflow from among the workflows based on a probability value assigned to the workflow, and presenting instructions for performing the workflow via the graphical user interface.

7. The computer-implemented method of claim 1, further comprising receiving feedback data indicating whether or not attempted implementation of the at least one instruction fixed the error, generating a feedback record including the feedback data, and retraining the AI model based on the feedback record.

8. A computer system comprising:
a processor set;
a set of one or more computer-readable storage media; and
program instructions, collectively stored in the set of one or more storage media, that causes the processor set to perform computer operations to:
receive a report of an error from an installation process of a software program as the installation process is being performed by a computer,
execute an artificial intelligence (AI) model on the report of the error such that the AI model generates a prediction comprising at least one instruction to fix the error, and present the at least one instruction via a graphical user interface of the computer associated with the installation process.

9. The computer system of claim 8, wherein the report of the error comprises at least one of an identifier of an error code, an error message associated with the error code, and an identifier of the software program, and the AI model is executed on the at least one of the identifier of the error code, the error message, and the identifier of the software program to predict the at least one instruction.

10. The computer system of claim 8, wherein the computer operations further comprise retrieving log data from previous successful installations of the software program, extracting, from the log data, steps performed during the previous successful installations, generating training data from the extracted steps performed during the previous successful installations, and training the AI model using the training data, wherein the executing the AI model is performed via the trained AI model.

11. The computer system of claim 8, wherein the computer operations further comprise retrieving knowledge base data of the software program from at least one data source, extracting error types and workflow steps to perform during installation to address the error types from the knowledge base data, generating training data to include the error types and the workflow steps to perform to address the error types, and training the AI model using the training data, wherein the executing the AI model is performed via the trained AI model.

12. The computer system of claim 8, wherein the computer operations further comprise executing the AI model to predict workflows to be performed to fix the error and a respective probability value for each of the workflows.

13. The computer system of claim 12, wherein the computer operations further comprise selecting a workflow from among the workflows based on a probability value assigned to the workflow, and presenting instructions for performing the workflow via the graphical user interface.

14. The computer system of claim 8, wherein the computer operations further comprise receiving feedback data indicating whether or not attempted implementation of the at least one instruction fixed the error, generating a feedback record including the feedback data, and retraining the AI model based on the feedback record.

15. A computer program product comprising:
a set of one or more computer-readable storage media; and
program instructions, collectively stored in the set of one or more computer-readable storage media, for causing a processor set to perform computer operations comprising:
retrieving historical information about software installation from at least one source;
extracting installation steps and associated errors from the retrieved historical information, the installation steps having been performed via previous successful installations;
generating training data from the extracted installation steps and from the extracted associated errors; and
using the training data to train an artificial intelligence model to predict an instruction to recommend for furthering a software installation that is stuck on an error.

16. The computer program product of claim 15, wherein the historical information comprises at least one of an identifier of an error code, an error message associated with the error code, and an identifier of the software program.

17. The computer program product of claim 15, wherein the historical information comprises log data from previous successful installations of a software program.

18. The computer program product of claim 15, wherein the historical information comprises knowledge base data of the software program from at least one data source and the extracted installation steps comprise workflow steps.

19. The computer program product of claim 15, wherein the training trains the AI model to predict workflows to be performed to fix the error and a respective probability value for each of the workflows.

20. The computer program product of claim 15, wherein the computer operations further comprise:
receiving feedback data indicating whether or not the at least one instruction fixed the error, generating a feedback record including the feedback data, and retraining the AI model based on the feedback record.
